(19) United States
(12) Patent Application Publication
(10) Pub. No.: US 2025/0334928 A1
(43) Pub. Date: Oct. 30, 2025

(54) TIMEPIECE COMPRISING AN INTERCHANGEABLE BEZEL

(71) Applicant: OMEGA SA, Biel/Bienne (CH)

(72) Inventor: Philippe LOETSCHER, Evilard (CH)

(73) Assignee: OMEGA SA, Biel/Bienne (CH)

(21) Appl. No.: 19/169,168

(22) Filed: Apr. 3, 2025

(30) Foreign Application Priority Data
Apr. 30, 2024 (EP) 24173545.5

(51) Int. Cl. G04B 45/00

(52) U.S. Cl. CPC G04B 45/0092

(57) ABSTRACT

A timepiece (1) including a middle (110) and an interchangeable bezel (200) fastened to said middle (110) by relative rotation of the bezel (200) relative to the middle (110), about a central axis (B), between an interlocking position and a locked position, by a bayonet fastening device (300), said bayonet fastening device (300) including first fastening elements (300a) formed on the middle (110) and second complementary fastening elements (300b) formed on the bezel (200), wherein the bayonet fastening device (300) includes a mechanical coding system (210, 116) for defining a single position in which said bezel (200) can be interlocked with the middle (110).

### CROSS-REFERENCE TO RELATED APPLICATIONS

This application is claims priority to European Patent Application No. 24173545.5, filed on Apr. 30, 2024, the disclosures of which are incorporated by reference herein their entireties

### TECHNICAL FIELD OF THE INVENTION

The invention relates to a timepiece, more particularly a wristwatch, comprising an interchangeable bezel, i.e. a bezel that can be easily changed and replaced by the wearer or user.

### TECHNOLOGICAL BACKGROUND

A number of devices are already known, in particular in a wristwatch, which allow one bezel to be replaced by another for aesthetic or functional purposes. With regard to aesthetics, this allows, for example, the colour of the most visible part of the watch to be matched to that of the wearer's clothing at a low cost. With regard to functionality, replacing the bezel allows, for example, the indications on said bezel to be modified, or a change to be made to the movement in order to create a multifunctional watch.

The patent EP0603353 describes a watch in which the replacement of the bezel allows the display of the current time to be switched to a “football” or “tennis” mode, the bezel chosen thus having indications relating to these sports and means allowing the horological mechanism to be controlled according to the rules of said sports.

In the known prior art, a removable bezel is fitted and held in place or, conversely, is replaced, using devices that can be classified into two broad categories, if we exclude inconvenient devices that require screwing, for example.

The removable bezel can be fastened by resilient means, as described in the patent GB 286107. These resilient means can be formed by a suitably shaped elastomer ring as described in Japanese utility model JP 4134178, or by a snap-fit device as described in the patent U.S. Pat. No. 5,005,161. In all of these resilient assemblies, it is difficult to find a good compromise between a device that is flexible enough to allow a user to replace the bezel without any particular effort and a device that is solid enough to prevent accidental loss.

To overcome the above drawback, a number of designs propose securing the bezel to the middle by means of a so-called “bayonet” device. This device consists of providing complementary male and female means in the bezel and in the upper part of the middle or case back, which complementary means engage within each other when the bezel is rotated.

However, known bayonet solutions cannot guarantee correct positioning of the bezel on the case, i.e. with a predefined orientation. This is because bayonet devices allow for a plurality of angular positions for mounting the bezel, which can result in the bezel being mounted in the wrong position relative to the case.

As a result, there is a need to improve bayonet fastening devices for interchangeable bezels on timepieces.

### SUMMARY OF THE INVENTION

To this end, the invention aims to propose a timepiece comprising a middle and an interchangeable bezel fastened to said middle by relative rotation of the bezel relative to the middle, about a central axis B, between an interlocking position and a locked position, by a bayonet fastening device, said bayonet fastening device comprising first fastening elements formed on the middle and second complementary fastening elements formed on the bezel, characterised in that the bayonet fastening device comprises a mechanical coding system for defining a single interlocking position in which said bezel can be interlocked with the middle.

In addition to the features mentioned in the preceding paragraph, the timepiece according to the invention can have one or more complementary features from among the following, considered either on an individual basis or according to any combination technically possible:
the mechanical coding system is formed by elements that are separate from the first fastening elements and from the second fastening elements;
the mechanical coding system comprises a coding member formed on the bezel and cooperating with a coding recess formed on the middle;
the mechanical coding system is formed by a specific shape or dimensions of one of the first fastening elements and, respectively, of one of the second fastening means intended to cooperate with said one of the first fastening elements;
the middle comprises two coding recesses communicating with an annular groove, forming the first fastening elements of the bayonet fastening device, and the bezel comprises two tabs, forming the second fastening elements of the bayonet device, which are configured to interlock in said two coding recesses and cooperate with the annular groove;
the bayonet fastening device comprises two resilient members housed in the annular groove of the middle and bearing between a circular shoulder and an upper collar of the middle, each of the resilient members being configured to cooperate with one of the two tabs of the bezel and to exert a force in an axial direction, parallel to the central axis B, on said at least one of the two tabs so as to force the bezel against said circular shoulder of said middle, when the bezel is in said locked position;
the two resilient members comprise anti-rotation studs configured to be inserted in orifices formed in said circular shoulder of the middle to block the movements of the two resilient members in the annular groove;
the bayonet fastening device comprises locking elements for locking said locked position of the bezel against rotation;
the bayonet fastening device comprises locking elements for locking said locked position of the bezel against rotation, the locking elements being formed by the cooperation of locking pins carried by the bezel and locking orifices formed in the circular shoulder;
said part comprises at least one stop arranged on said circular shoulder of the middle to block rotation of the bezel about the central axis B in a first direction of rotation when said bezel is in a locked position and/or in a second direction of rotation when said bezel is in a removal position.

### BRIEF DESCRIPTION OF THE FIGURES

The purposes, advantages and features of the present invention will be better understood upon reading the detailed description given below with reference to the following figures:

FIG. 1 is an exploded, perspective view of an example embodiment of a case of a timepiece, for example a wristwatch case, comprising a middle, an interchangeable bezel interlocked with the middle by a bayonet fastening device;

FIG. 2 shows a top view of the case illustrated in FIG. 1;

FIG. 3 is a perspective view of the interchangeable bezel shown in FIG. 1;

FIG. 4 is a side view of the case illustrated in FIG. 1, showing in particular a resilient member housed in an annular groove in the middle and intended to receive the interchangeable bezel and hold it in position;

FIG. 5 is a cross-sectional view of the case shown in FIG. 1, partially illustrating how the interchangeable bezel is held axially on the middle.

In all figures, common elements bear the same reference numerals unless indicated otherwise.

### DETAILED DESCRIPTION OF THE INVENTION

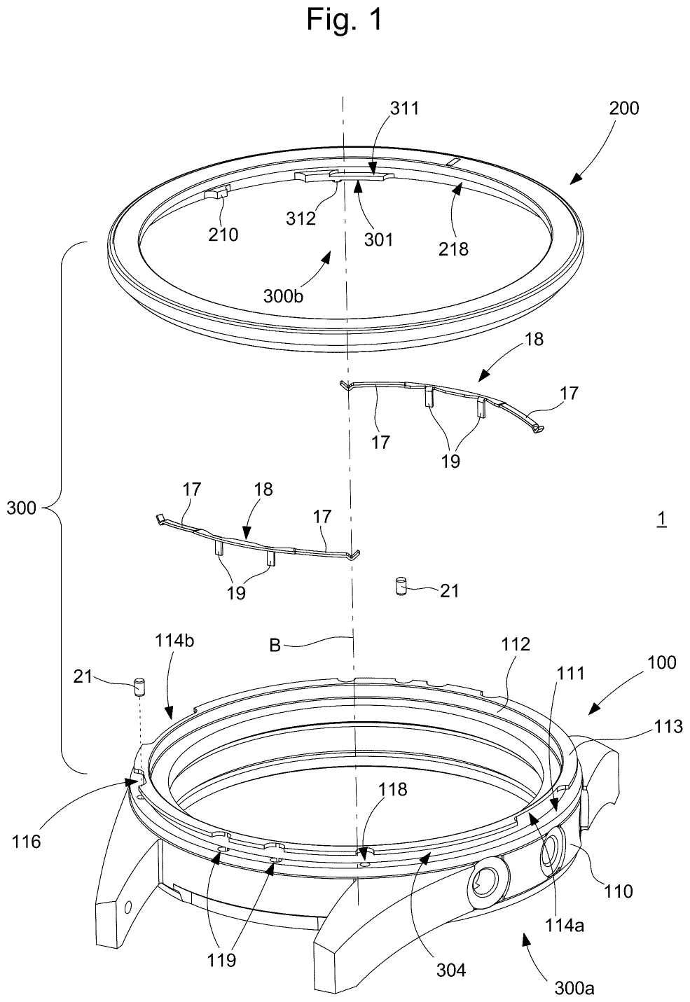

FIG. 1 is an example embodiment of a case 100 of a timepiece 1, for example a wristwatch. FIG. 1 shows an exploded, perspective view of a case 100 having a central axis B and comprising a middle 110 configured to be closed on one side by a case back (not shown) and on the other, upper side by a crystal (not shown).

In general, the expressions “radially internal” and “radially external” used herein are to be considered in relation to the central axis B of the case 100. Thus, a radially internal portion, side or face is radially closer to the central axis B than a radially external portion, side or face.

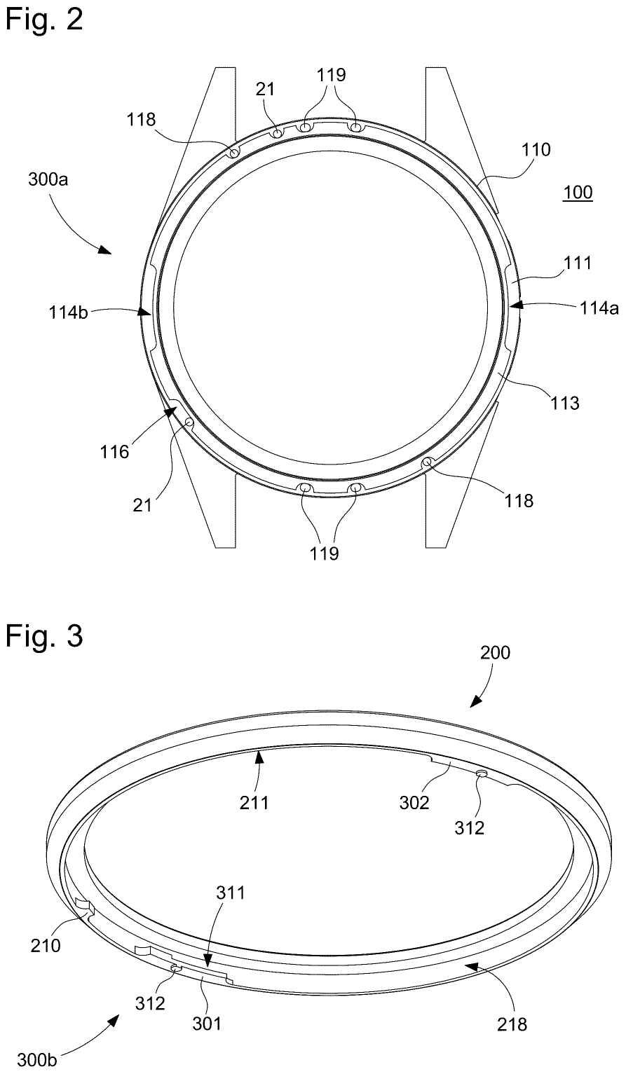

In particular, FIG. 2 shows a top view of the case 100 of the timepiece shown in FIG. 1.

The case 100 comprises a horological movement (not shown) housed in the internal space delimited by the middle 110.

For example, the middle 110 is made of metal, ceramic, polymer or a combination of different materials.

The case 100 comprises a bezel 200, typically surrounding the crystal. According to the invention, the bezel 200 is an interchangeable bezel, i.e. it can be easily removed by a user without the use of specific tools. Such a bezel 200 is illustrated more particularly in FIG. 3.

The interchangeable bezel 200 is interlocked with and rigidly connected to the case 100 by a bayonet fastening device 300, the various male and female elements whereof are provided both on the middle 110 and on the bezel 200.

The bayonet fastening device 300 is configured to lock and unlock the bezel 200 by rotating the bezel 200 relative to the middle 110 about the central axis B, for example by around 30° between a first interlocking position and a second locked position.

By way of example, the locking direction is shown to be clockwise. However, the locking direction can also be counter-clockwise.

The interchangeable bezel 200 can be made of metal, ceramic, polymer or a combination of different materials.

The upper part of the middle 110, i.e. the part at the portion intended to receive the bezel 200, comprises a circular shoulder 111 extending substantially in a plane perpendicular to the central axis B.

The circular shoulder 111 is shaped to form a bearing surface to support the bezel 200, particularly when the latter is in the locked position.

The middle 110 comprises an annular sleeve 112 extending substantially perpendicularly to the plane formed by the circular shoulder 111. The sleeve 112 extends, for example, at a radially internal edge of the circular shoulder 111.

The upper part of the sleeve 112 ends in an upper collar 113, which is typically circular in shape and which extends in a plane substantially perpendicular to the central axis B, and preferably in a plane parallel to the plane of the circular shoulder 111.

The sleeve 112 delimits an annular groove 304 located between the circular shoulder 111 and the upper collar 113. The annular groove 304 belongs to the first fastening elements 300a of the bayonet fastening device 300 according to the invention, provided on the middle 110, the annular groove 304 being configured to receive complementary second fastening elements 300b of the bayonet fastening device 300, provided on the bezel 200.

The first fastening elements 300a further comprise interlocking recesses 114a, 114b formed on the periphery of the upper collar 113 and communicating with the annular groove 304.

The interlocking recesses 114a, 114b form openings allowing the passage of the second fastening elements 300b of the bezel 200 during an axial displacement of the bezel 200 along the central axis B. These interlocking recesses 114a, 114b are formed, for example, by localised thinning of the periphery of the upper collar 113 allowing the second fastening elements 300b to be inserted into the annular groove 304 of the middle 110.

The second fastening elements 300b of the bayonet fastening device 300 are, for example, formed by two tabs 301, 302 projecting from a radially internal surface 218 of the bezel 200, in a radial direction relative to the central axis B of the case 100.

The two tabs 301, 302 extend in a radial direction towards the centre of the bezel 200 and over a predetermined angular sector.

The shape and dimensions of the tabs 301, 302 are determined so as to cooperate with the shape and dimensions of the interlocking recesses 114a, 114b.

The two tabs 301, 302 can have different shapes or dimensions from each other, so that one tab 301 can be configured to cooperate with only one interlocking recess 114a and the other tab 302 is configured to cooperate with only the other interlocking recess 114b of the upper collar 113, such that the bayonet fastening device 300 comprises a foolproof mechanical coding system formed by the differences in shape and/or dimensions of the first fastening elements 300a and of the second fastening elements 300b respectively. Thus, the bezel 200 can only be interlocked in one and only one interlocking position, which corresponds to a single angular position of the bezel 200 about the central axis B relative to the middle 110.

According to another alternative embodiment, as shown in the figures, a dedicated coding member 210 (or positioning member) which is separate from the fastening elements of the bayonet fastening device 300 of the invention can be used. The coding member 210 is shaped to cooperate with a coding recess 116 (or positioning recess) of complementary shape. In this alternative embodiment, the tabs 301, 302 can be identical in shape and dimensions, and can cooperate with interlocking recesses 114a, 114b of identical, complementary shape and dimensions.

Preferably, the coding recess 116 has a specific shape or dimensions that is/are different from that/those of the interlocking recesses 114a, 114b, or the coding member 210 respectively has a specific shape or dimensions that is/are different from that/those of the tabs 301, 302. Thus, the bezel 200 can only be interlocked in one and only one interlocking position, which corresponds to a single angular position of the bezel 200 about the central axis B relative to the middle 110.

For example, as shown in the figures, the male coding member 210 is carried by the bezel 200, and more particularly the coding member 210 projects from the radially internal surface 218 of the bezel 200.

To ensure that the bezel 200 is held in the locked position on the middle 100, the bayonet fastening device 300 further comprises resilient members 18, for example in the form of strip springs, housed and held in position in the annular groove 304 of the middle 110. The resilient members 18 are configured to exert a force in an axial direction, parallel to the central axis B, on the tabs 301, 302 of the bezel 200 at least when the bezel 200 is in the locked position in the middle 110.

In the example embodiment shown, two resilient members 18 are inserted and housed in the annular groove 304 of the middle 110, the two resilient members 18 bearing against the circular shoulder 111 and against the lower face of the upper collar 113.

Each resilient member 18 is configured to bear against a tab 301, 302, at least when the bezel 200 is in the locked position on the middle 110.

Each resilient member 18 comprises a main body and anti-rotation studs 19 configured to be inserted into orifices 119 formed in the circular shoulder 111 of the middle 110. Thus, when the bezel 200 is interlocked and rotated to reach the locked position, the resilient members 18 are not rotated by the tabs 301, 302 of the bezel 200 and remain in position in the annular groove 304, mechanically constrained between the bottom of the orifices 119 and the lower face of the upper collar 113.

Each resilient member 18 comprises at least one resilient end lug 17 extending from the main body and interacting with a tab 301, 302 of the bezel 200, when the bezel 200 is being locked and when the bezel 200 is in the locked position.

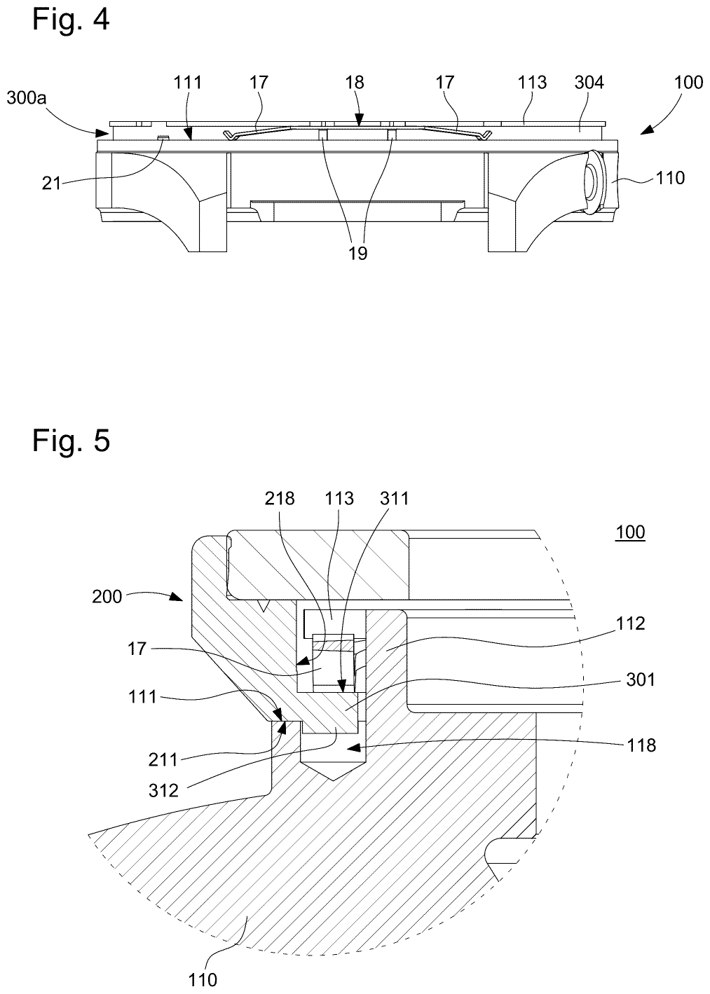

When the resilient members 18 are in the rest position, i.e. when the bezel 200 is not engaged with the middle 110, the resilient lug 17 bears on the circular shoulder 111, as shown in FIG. 4.

When the bezel 200 is rotated about the central axis B, the tabs 301, 302 come into contact with the end of the resilient lugs 17. The V-shape of the end of the resilient lugs 17 provides an inclined engagement surface allowing the tabs 301, 302 to engage under the ends of the resilient lugs 17 while resiliently stressing the resilient lugs 17 by moving towards the upper collar 113, the main body of the resilient member 18 being stressed at the top by the upper collar 113.

When the bezel 200 is in the locked position, the resilient lugs 17 cooperate with an upper bearing surface 311 of the tabs 301, 302, by exerting an axial force thereon to force the bezel 200 to bear against the circular shoulder 111, by the resilient recovery of the resilient lugs 17.

To this end, FIG. 5 illustrates a partial cross-sectional view of the case 100 comprising the bezel 200 in the locked position on the middle 110. In this locked position, the end of at least one resilient lug 17 of each resilient member 18 bears against the upper bearing surface 311 of the tabs 301, 302.

In the example embodiment illustrated, each resilient member 18 comprises two resilient lugs 17 opposite each other and located on either side of the main body and of the anti-rotation studs 19. The use of two opposing resilient lugs 17 makes it possible to balance the stresses on the resilient member 18, particularly when the bezel 200 is in the locked position. Thus, when one of the resilient lugs 17 is axially bearing on a tab 301, 302, the other resilient lug 17 is always bearing on the circular shoulder 111, which makes it possible to guarantee dimensional stability of the resilient member 18 in the annular groove 304 and to guarantee that minimum axial stress is exerted by the resilient member 18 on the tabs 301, 302, by resilient deformation of one of the resilient lugs 17.

In addition to the axial stress exerted on the bezel 200 by the resilient members 18, the bayonet fastening device 300 can comprise elements for locking the locked position of the bezel 200 against rotation, to prevent undesired reverse rotation of the bezel. These rotation-locking elements are produced by the cooperation of locking pins 312 carried by the bezel 200 and of locking orifices 118 formed in the circular shoulder 111.

The locking pins 312 project from a lower face 211 of the bezel 200. Preferably, the locking pins 312 are located at the tabs 301, 302.

Thus, when the bezel 200 is interlocked and rotated, the locking pins 312 first slidingly bear against the circular shoulder 111 until they reach the locking orifices 118 formed in the circular shoulder 111. Under the resilient recovery action imparted by the resilient members 18 on the tabs 301, 302, the locking pins 312 interlock with each other in the locking orifices 118 when they are positioned opposite one another, preventing any rotation, in particular reverse rotation, of the bezel 200 without any action on the part of the user.

In the example embodiment illustrated, the bezel 200 comprises two locking pins 312 configured to cooperate with two locking orifices 118 formed on the circular shoulder 111. However, it is possible to provide a different number of rotation-locking elements while still remaining within the context of the invention.

The timepiece 1 can also, additionally, comprises stops 21 to stop the rotation of the bezel 200 when the middle 110 is being mounted and/or removed.

For example, the stops 21 are positioned on the periphery of the circular shoulder 211 so as to block the bezel 200 from rotating about the central axis B, by cooperating with the tabs 301, 302 and/or the coding member 210, if present.

For example, the stops 21 are reliefs formed on the circular shoulder 111 which act as obstacles to the movements of the tabs 301, 302 and/or the coding member 210 of the bezel 200.

For example, the stops 21 are pins rigidly connected to orifices provided for this purpose in the circular shoulder 111. These pins act as obstacles to the movements of the tabs 301, 302 and/or of the coding member 210 of the bezel 200.

In the example embodiment illustrated in the various figures, a first stop 21 is positioned on the circular shoulder 111 in a region close to a resilient member 18 to cooperate with one end of a tab 301, 302 in order to block the bezel 200 from rotating during mounting, if the latter were forced beyond the locked position, imparted in particular by the interlocking of the locking pins 312 in the locking orifices 118.

In the example embodiment illustrated in the various figures, a second stop 21 is positioned on the circular shoulder 111 in a region close to the coding recess 116 so as to cooperate with the coding member 210. This second stop 21 makes it possible to block the bezel 200 against rotation during removal, in particular to indicate the position for interlocking and removing of the bezel 200 from the middle 110 in which the tabs 301, 302 are located facing the interlocking recesses 114a, 114 so that the bezel 200 can be removed from the middle 110 by axial displacement along the central axis B.

### Method for Mounting and Removing an Interchangeable Bezel According to the Invention

The bezel 200 is mounted on and removed from the middle 110 as follows.

Initially, the user positions the bezel 200 facing the middle 10 so as to line up the various protuberances of the bezel 200, formed by the tabs 301, 302 and, if present, the coding member 210, with the various recesses in the upper collar 113 formed by the interlocking recesses 114a, 114b and the coding recess 116, if present.

When the various elements are facing each other, the user can interlock the bezel 200 with the middle 110 so as to position the tabs 301, 302 and, if present, the coding member 210, in the annular groove 304 by axial displacement along the central axis B. In this position, the bezel 200 is in the interlocked position.

In this interlocked position of the bezel 200, the locking pins 312 bear on the circular shoulder 111 of the middle 110.

The user then rotates the bezel, for example clockwise in the example shown in the figures, about the central axis B, so as to move the tabs 301, 302 of the bezel 200 into the annular groove 304. Once the tabs 301, 302 are no longer facing the interlocking recesses 114a, 114, the bezel 200 is engaged on the middle 110 and held axially, along the central axis B, between the circular shoulder 111 on the one hand and the upper collar 113 on the other, although there can be a slight axial operating clearance.

As the bezel 200 continues to rotate, the tabs 301, 302 come into contact with the resilient lugs 17 of the resilient members 18 and engage under the resilient lugs 17, imposing a resilient deformation on the resilient lugs 17, the resilient members 18 being locked against rotation in the annular groove 304.

As the bezel 200 again continues to rotate, the locking pins 312 come to face the locking orifices 118. Under the axial stress imposed by the resilient lugs 17 on the bezel 200 via the tabs 301, 302, the locking pins 312 interlock in the locking orifices 118, and the bezel 200 performs an axial movement in the direction of the circular shoulder 111, so that the lower face 211 of the bezel 200 is in contact with and bears against the circular shoulder 111. In this position, the bezel 200 is in the locked position. Thus, without any voluntary action on the part of the user, the bezel 200 is locked in position, and reverse rotation is not possible until an upward axial force is imposed on the bezel 200 to release the locking pins 312 from the locking orifices 118.

In this locked position, a tab 301, 302, in this case the tab 301, can bear against a first stop 21. A slight clearance can also be provided between the tab 301 and the first stop 21 when the bezel 200 is in this locked position, the angular position of the bezel 200 being marked by the cooperation of the locking pins 312 and the locking orifices 118.

To remove the bezel 200, the user must move the bezel 200 axially along the central axis B, detaching it from the circular shoulder 111. The user must thus exert a force on the bezel 200 that exceeds the axial stress imposed by the resilient members 18, so as to disengage the locking pins 312 from the locking orifices 118. The user can then rotate the bezel in the opposite direction to the mounting direction, in this case anti-clockwise, until the tabs 301, 302 and, if present, the coding member 210, line up with the various recesses 114a, 114b, 116 in the upper collar 113, and thus position the bezel 200 in a removal position allowing the bezel 200 to be removed from the middle 110. This removal position is angularly very close to, or even identical to, the interlocking position described above for mounting the bezel 200.

In this removal position, the positioning member, or at least one tab 301, 302, is in abutment against a second stop 21.

The user can thus mount a new bezel 200 on the middle 110 to modify its aesthetic appearance or to modify the display carried by the bezel 200 so as to modulate the information displayed by a chronograph function of the horological movement with which the timepiece 1 is fitted.

1. A timepiece comprising a middle and an interchangeable bezel fastened to said by relative rotation of the bezel relative to the middle, about a central axis, between an interlocking position and a locked position, by a bayonet fastening device, said bayonet fastening device comprising first fastening elements formed on the middle and second complementary fastening elements formed on the bezel, wherein said bayonet fastening device comprises a mechanical coding system for defining a single position in which said bezel can be interlocked with the middle.

2. The timepiece according to claim 1, wherein said mechanical coding system is formed by elements that are separate from the first fastening elements and from the second fastening elements.

3. The timepiece according to claim 2, wherein said mechanical coding system comprises a coding member formed on the bezel and cooperating with a coding recess formed on the middle.

4. The timepiece according to claim 1, wherein said mechanical coding system is formed by a specific shape or dimensions of one of the first fastening elements and, respectively, of one of the second fastening elements intended to cooperate with said one of the first fastening elements.

5. The timepiece according to claim 1, wherein said middle comprises two interlocking recesses communicating with an annular groove, forming the first fastening elements of the bayonet fastening device, and in that the bezel comprises two tabs, forming the second fastening elements of the bayonet device, which are configured to interlock in said two interlocking recesses and cooperate with said annular groove.

6. The timepiece according to claim 5, wherein said bayonet fastening device comprises two resilient members housed in the annular groove of the middle and bearing between a circular shoulder and an upper collar of the middle, each of the resilient members being configured to cooperate with one of the two tabs of the bezel and to exert a force in an axial direction, parallel to the central axis, on said one of the two tabs so as to force the bezel against said circular shoulder of said middle, when the bezel is in said locked position.

7. The timepiece according to claim 6, wherein said two resilient members comprise anti-rotation studs configured to be inserted into orifices formed in said circular shoulder of the middle.

8. The timepiece according to claim 1, wherein said bayonet fastening device comprises locking elements for locking said locked position of the bezel against rotation.

9. The timepiece according to claim 6, wherein said bayonet fastening device comprises locking elements for locking said locked position of the bezel against rotation, the locking elements being formed by the cooperation of locking pins carried by the bezel and locking orifices formed in the circular shoulder.

10. The timepiece according to claim 1, wherein said timepiece comprises at least one stop arranged on said circular shoulder of the middle to block rotation of the bezel about the central axis in a first direction of rotation when said bezel is in a locked position and/or in a second direction of rotation when said bezel is in a removal position.
